(19) United States
(12) Patent Application Publication
(10) Pub. No.: US 2018/0375569 A1
(43) Pub. Date: Dec. 27, 2018

(54) METHOD OF TELECOMMUNICATION IN A SYSTEM WITH MULTI-SPOT GEOGRAPHICAL COVERAGE, CORRESPONDING TERRESTRIAL STATION AND RELAY DEVICE

(71) Applicant: IRT Saint Exupery, Toulouse (FR)

(72) Inventors: Gilles Mesnager, Clermont Le Fort (FR); Jacques Decroix, Odars (FR); Jacques Sombrin, Toulouse (FR)

(21) Appl. No.: 16/120,850

(22) Filed: Sep. 4, 2018

Related U.S. Application Data
(63) Continuation-in-part of application No. PCT/EP2017/054968, filed on Mar. 2, 2017.

(30) Foreign Application Priority Data
Mar. 4, 2016 (FR) 1651844

(51) Int. Cl. H04B 7/185

(52) U.S. Cl. CPC H04B 7/18513

(57) ABSTRACT

A method of telecommunications is proposed in a multi-spot geographical coverage system having an outbound path to transmit information, via a satellite or aircraft type relay device, from a plurality of ground stations to a plurality of terminals located in spots. Each downlink of the outbound path is associated with a color in an N-color re-use scheme with N≥2. For at least one color (or sub-color), one of the ground stations transmits to the relay device all the information intended for transmission by the relay device with this color or (sub-color).

### 1. CROSS-REFERENCE TO RELATED APPLICATION

This Application is a Section 371 National Stage Application of International Application No. PCT/EP2017/054968, filed Mar. 2, 2017, the content of which is incorporated herein by reference in its entirety, and published as WO 2017/149100 on Sep. 8, 2017, not in English.

### 2. TECHNICAL FIELD

The field of the invention is that of telecommunications via a satellite or aircraft type relay device. The term “aircraft” is understood to mean an airplane, a drone, a dirigible or a balloon. It is for example a high altitude platform (HAP) or high altitude platform station or high altitude pseudo-satellite (HAPS) also called a stratospheric platform.

Such a satellite or aircraft type relay device possesses a reception antenna that receives signals sent out from ground stations or ground stations. In the relay device, these signals are filtered, transposed in frequency and amplified and then retransmitted (by transmission antennas) towards Earth.

More specifically, the invention relates to a method of telecommunications, via a satellite or aircraft type relay device, in a system with multi-spot geographical coverage or more simply a multi-spot system with an N-color reuse scheme or pattern, this method relating to the optimizing of the outbound path and enabling the implementation of intra-system interference cancellation algorithms.

### 3. TECHNOLOGICAL BACKGROUND

Here below in this document, we shall strive more particularly to describe the problems and issues existing in satellite telecommunication systems. The invention is of course not limited to this particular field of application but is of interest for any type of telecommunications via a satellite or aircraft type relay device that has to cope with proximate or similar problems and issues.

Satellite telecommunication systems generally use short-wave propagation in vacuum as their medium. These waves are characterized by their wavelength and their bandwidth. The increase in the bit rate of information to be transmitted (high bit rate telecommunications) leads to the increase in the required bandwidth. The increasing shortage of available short-wave frequency bands is making it necessary to find novel solutions.

A first known solution used to increase capacity is that of migration towards higher frequency bands, for example from the Ku band to the Ka band or presently to the Q/V band which is even higher. The solution relies on advances in technologies for processing increasingly faster digital or analog signals. These technologies are however tending to approach their limits because of technological limits related to making equipment and because of saturation of the frequency planes. At present, a further reduction of wavelengths is being envisaged. This would be done by passing from radiofrequency propagation to optical propagation (laser telecommunication). However, the trade-off would be the requirement of total control over free-space atmospheric propagation which to date is at a level of development that is as yet insufficient for optical frequencies.

A second known solution is that of optimizing the spectral efficiency of transmission by working in two directions: improving the directivity of the antenna patterns that reduces co-frequency interference of spots adjacent to the spot of interest and seeking waveforms that maximize the number of bits transmitted in a given frequency band.

A third prior art solution for increasing the capacity of the satellite telecommunication systems (i.e. to convey high bit rates of information) relies on the implementation of multi-spot geographical coverage systems using a frequency re-use pattern or scheme known as an “N-color re-use scheme” (N is also called a re-use factor). An example of such a multi-spot geographical coverage system is presented in detail in the patent document US2009/0023384A1. The term “color” is understood to mean a frequency band or else a pair associating a frequency band and a polarization used to transmit information. By definition, two colors are distinct if their frequency bands do not overlap or if their polarizations are different. On the downlink of the outbound path, each color is re-used on different geographical zones (call spots).

FIG. 1 illustrates an example of such a satellite telecommunication system with multi-spot geographical coverage. FIG. 2A illustrates the deployment of the multi-spot system of FIG. 1 in the European zone.

The system comprises an outbound path for transmitting information via a satellite 1, from a plurality of ground stations (only one station, referenced GW1, is represented in FIG. 1) towards a plurality of terminals (four terminals referenced Ti, Tj, Tk and Tl are shown in FIG. 1) located in spots (referenced spot 1 to spot 4) distributed in a terrestrial geographical coverage zone. The satellite 1 (and more specifically its payload) comprises an input multiplexing block 11, an amplification block 12 and an output multiplexing block 13. The outbound path comprises a plurality of uplinks (only one uplink referenced 2a is shown in FIG. 1), each from one of the ground stations towards the satellite, and a plurality of downlinks (four downlinks referenced 3a, 4a, 5a and 6a are shown in FIG. 1), each from the satellite to one of the spots. The system is of a “unicast” type if only one terminal can be used in each spot or of a “multicast” type if several terminals can be used simultaneously in each spot.

Each of the uplinks uses N first colors around an uplink frequency f_{up with} N≥2. In the example of FIG. 1 we have N=4 and the uplink 2a (from the ground station GW1) is associated with the colors C_{1,m}, C_{2,m}, C_{3,m} and C_{4,m} which respectively transmit the pieces of information I1, I2, I3 and I4. The color C_{1,m} corresponds to the pair associating a frequency band below the frequency fᵤₚ and a right-hand circular polarization. The color C_{2,m} corresponds to the pair associating a frequency band higher than the frequency fᵤₚ and a right-hand circular polarization. The color C_{3,m} corresponds to the pair associating a frequency band below the frequency fᵤₚ and a left-hand circular polarization. The color C_{4,m} represents a pair associating a frequency band higher than the frequency fᵤₚ and a left-hand circular polarization.

Each of the downlinks is associated with a second color in a re-use pattern with N second colors around a downward frequency f_{down}, with N≥2. In the example of FIG. 1, we have N=4 and the downlinks 3a, 4a, 5a and 6a are associated with the colors C_{1,d}, C_{2,d}, C_{3,d} and C_{4,d} respectively and these colors respectively transmit the pieces of information I1, I2, I3 and I4 (coming from the ground station GW1). The color C_{1,d} corresponds to the pair associating a frequency band below the frequency f_{down} and a right-hand circularly polarized frequency (RHCP) The color C_{2,d} corresponds to the pair associating a frequency band higher than the frequency f_{down} or a right-hand circular polarization. The color C_{3,d} corresponds to the pair associating a frequency band below the frequency f_{down} and a left-hand circular polarization (LHCP). The color C_{4,d} corresponds to the pair associating a frequency band higher than the frequency f_{down} and a left-hand circular polarization.

In the example of FIG. 1, the system also comprises a return path to transmit information through the satellite from the plurality of terminals of the plurality of ground stations. The return path comprises a plurality of uplinks (four referenced 3b, 4b, 5b and 6b are shown in FIG. 1), each from one of the terminals to the satellite and a plurality of downlinks (one, reference 2b, is shown in FIG. 1), each from the satellite to one of the ground stations.

In a satellite telecommunication system with multi-spot coverage with an N-color re-use scheme, the separation of the information carried at the same color is done by the patterns of the sending antennas of the satellite. It is therefore the directivity of the sending antennas of the satellite that enable concentration of the energy of the signal sent out in a given color on the corresponding spots. This “spatial filtering” limits interference between two spots of a same color. But it is unfortunately imperfect and there is interference between spots of a same color (also called intra-system interference) that limits the capacity of the system.

There is therefore a need to cancel out these intra-system interferences or at the very least to limit them to the utmost in order to enable the use of more aggressive color re-use schemes and thus multiply the capacity of the satellite system. This is a major issue in space telecommunications.

A known solution for limiting intra-system interference consists in increasing the number of colors and isolating the spots of a same color by interposing spots of different colors. This solution has the drawback of halving the theoretical capacity of the system whenever the number of colors is doubled.

Another known solution is that of using interference cancelling algorithms in the ground stations. These algorithms enable the subtraction at the time of sending (i.e. in the ground stations), for the information intended for a spot, of the interfering information intended for adjacent spots of a same color.

In present-day configurations, several ground stations are used for transmission, to the satellite, of information that this satellite will retransmit with a same color. In other words, referring to FIG. 3 described in detail here below, for a given color (for example C_{1,d}) used by the satellite for transmission towards several spots (for example the spots 1, 5, 9 and 13), the corresponding pieces of information (for example I1, I5, I9 and I13) are given to the satellite by several ground stations (GW1 to GW4).

One example of such a configuration is illustrated in the diagram of FIG. 3 representing the signals received and transmitted by the satellite 1. In this example, the system comprises 16 spots (i.e. the satellite sends on 16 beams with 16 downlinks) powered by four ground stations GW1 to GW4.

The ground station GW1 transmits pieces of information I1, I2, I3 and I4 to the satellite on the first colors C_{1,m}, C_{2,m}, C_{3,m} and C_{4,m} respectively (see definitions further above). The ground station GW2 transmits pieces of information I5, I6, I7 and I8 to the satellite on the same first colors C_{1,m}, C_{2,m}, C_{3,m} and C_{4,m} respectively. The ground station GW3 transmits, to the satellite, the pieces of information I9, I10, I11 and I12 on the same first colors C_{1,m}, C_{2,m}, C_{3,m} and C_{4,m} respectively. The ground station GW4 transmits, to the satellite, the pieces of information I13, I14, I15 and I16 on the same first colors C_{1,m}, C_{2,m}, C_{3,m} and C_{4,m} respectively.

The satellite retransmits the pieces of information I1, I2, I3 and I4 towards the spots 1, 2, 3 and 4 respectively, on the second colors C_{1,d}, C_{2,d}, C_{3,d} and C_{4,d} respectively (cf. definitions here above). It retransmits the pieces of information I5, I6, I7 and I8 towards the spots 5, 6, 7 and 8 respectively on the same second colors C_{1,d}, C_{2,d}, C_{3,d} and C_{4,d} respectively. It retransmits the pieces of information I9, I10, I11 and I12 towards the spots 9, 10, 11 and 12 respectively on the same second colors C_{1,d}, C_{2,d}, C_{3,d} and C_{4,d} respectively. It retransmits the pieces of information I13, I14, I15 and I16 towards the spots 13, 14, 15 and 16 respectively on the same second colors C_{1,d}, C_{2,d}, C_{3,d} and C_{4,d} respectively.

Typically, and as shown in FIG. 3, the architecture of the payload of the satellite comprises a processing chain (or processing line) (itself comprising two blocks 31A/B/C/D and 32A/B/C/D) to process the signals coming from each of the ground stations. For example, for signals coming from the ground station GW1, the processing chain comprises the blocks 31A and 32A. The block 31A itself comprises a polarization duplexer or OMT (orthomode or orthogonal mode transducer) 33 enabling the separation of the signals according to their polarization (right-hand circular polarization (RHCP) or left-hand circular polarization (LHCP)), and two arms each dedicated to a distinct polarization. Each arm of the block 31A comprises a first filter (H0) 34a, 34b followed by a frequency transposer 36a, 36b (performing a transposition of the received spectrum, from the frequency fᵤₚ towards the frequency f_{down}, by multiplication by a frequency given by a local oscillator (LO) 35 and a second filter (H1) 37a, 37b. The block 32A also comprises two arms, each dedicated to a distinct polarization. Each arm of the block 32A comprises an amplifier (a TWTA or travelling wave tube amplifier) 38a, 38b (receiving the output signal from the second filter of one of the two arms of the block 31A), the output of which feeds two filters (H2) 39a, 39c and (H3) 39b, 39d disposed in parallel and enabling the signal to be sub-divided into two sub-bands corresponding to the colors C_{1,d} and C_{2,d} for the right-hand circular polarization (colors used for the transmission towards the spots 1 and 2) and to the colors C_{3,d} et C_{4,d} for the left-hand circular polarization (colors used for transmission towards the spots 3 and 4).

This architecture of the payload of the satellite has been adopted because it has the advantage of simplifying the processing chains, each arm of which requires only one frequency transposer (36a or 36b for the two arms of the processing chain for processing the signals coming from the ground station GW1).

It can be seen in the example of FIG. 1 that the pieces of information I1, I5, I9 and I13, transmitted by the satellite with the same color C_{1,d} to the spots 1, 5, 9 and 13 respectively come from the four ground stations GW1 to GW4 (placed apart by several hundreds of kilometers for the reasons of separation referred to here above). The same is the case for the pieces of information I2, I6, I10 and I14 transmitted with the color C_{2,d} towards the spots 2, 6, 10 and 14 respectively; the pieces of information I3, I7, I11 and I15 transmitted with the color C_{3,d} towards the spots 3, 7, 11 and 15 respectively; and the pieces of information I4, I8, I12 and I16 transmitted with the color C_{4,d} towards the spots 4, 8, 12 and 16 respectively.

The use of interference cancellation algorithms therefore requires that each ground station sending information towards the satellite intended for a spot of a given color (i.e. when the satellite re-sends with the same color) knows the interfering information, i.e. the information transmitted by the satellite to the first adjacent spots of the same color.

In order that each ground station may have knowledge of the interfering information enabling it to use the interference cancelling algorithms, the following especially are known:
a first known architecture in which a ground infrastructure, constituted by a communications network between the ground stations, is used to convey interfering information as well as correction parameters to be applied in order to correct the interference. An example of meshing or networking between 11 ground stations (GW1 to GW1) is illustrated in FIG. 2B (European coverage);
a second known architecture, in which a unique point of a ground architecture knows all the information intended for the different spots. This unique point groups together all the modulation equipment (which, in the first architecture, is distributed among the ground stations) and generates a radio signal (distributed among several carriers) that is digitized and dispatched to all the ground stations through optic fiber links.

For the high-capacity systems (for example more with than a hundred spots), the two known architectures are inapplicable (or hardly applicable) in practice. Indeed, this would lead to assumptions of information transfers that would be prohibitive (in terms of information throughput rate, synchronization etc.) among ground stations (the case of the first architecture) or between the unique point and the ground stations (in the case of the second architecture).

### 4. SUMMARY OF THE INVENTION

One particular embodiment of the invention proposes a method of telecommunications in a multi-spot geographical coverage system comprising an outbound path to transmit information via a satellite or aircraft type relay device from a plurality of ground stations to a plurality of terminals located in spots distributed in a terrestrial geographical coverage zone, the outbound path comprising a plurality of uplinks, each from one of the ground stations to the relay device, and a plurality of downlinks, each from the relay device to one of the spots, each of the downlinks being associated with a color in an N-color re-use scheme, with N≥2, each color corresponding to a distinct frequency band or to a distinct pair associating a frequency band and a polarization. For at least one given color among the N colors or for at least one given sub-color of at least one given color, one of the ground stations transmits to the relay device all the information intended for transmission by the relay device with said at least one given color or with said at least one given sub-color, said at least one given sub-color being one of the M sub-colors resulting from a division of the given color and being each associated with a sub-band of the frequency band associated with the given color or with a distinct pair associating a sub-band of the frequency band associated with the given color and the polarization associated with the given color, each downlink associated with said at least one given color using the M sub-colors, with M≥2.

Thus, this particular embodiment of the invention relies on a wholly novel and inventive approach in which a same ground station is made to transmit information that can generate intra-system interference because this information will be retransmitted by the relay device (of the satellite or aircraft type) with a same color and a same sub-color. This ground station can then, for this information, apply the intra-system interference cancellation algorithms without its being necessary to set up a communications link between this ground station and the other ground stations (this is the case of the first known architecture), or else between this ground station and a unique point (this is the case of the second known architecture). In other words, the proposed solution enables the implementing of the intra-system interference cancellation algorithms while preventing information transfers between ground stations through the terrestrial network.

In a first particular implementation, each of the N ground stations is dedicated to a specific color among the N colors and transmits, to the relay device, all the information intended for retransmission by the relay device with said specific color.

This first implementation requires only N ground stations. It is adapted to the case where each of these N ground stations possesses the capacity to convey all the information to one of the N colors.

In a second particular implementation, each of the M ground stations is dedicated to a specific sub-color among the M sub-colors resulting from the division of said at least one given color and transmits, to the relay device, all the information to be transmitted by the relay device with said specific sub-color.

While enabling the implementation of the intra-system interference cancellation algorithms, this second implementation makes it possible to surpass the above-mentioned limits of the first implementation. Indeed, if a ground station does not have the capacity to convey all the information of one of the N colors, then this color is divided into M sub-colors and this ground station is replaced by M ground stations each possessing the capacity to convey all the information of one of the M sub-colors.

Another advantage of this first implementation is that it prevents any total loss of coverage in the spots associated with a color divided into several sub-colors. Indeed, even in the event of unavailability of a ground station transmitting the information on one of the sub-colors of the divided color to the (satellite or aircraft type) relay device, the proposed solution enables partial coverage of this spot because it receives information from the other sub-colors of the divided color (transmitted by ground stations other than those that are unavailable).

According to one particular aspect of this second implementation, each of S ground stations is dedicated to a specific sub-color among S sub-colors and transmits, to the relay device, all the information intended for transmission by the relay device with said specific sub-color, where S=M₁+M₂+ . . . +M_{N}, with Mᵢ being the number of sub-colors of the i^{th} of the N colors, iε{1 . . . N}.

In this particular case of the second implementation, each of the N colors is divided into sub-colors and the number S of ground stations corresponds to the total number of sub-color resulting from the division of the N colors.

According to one particular characteristic, the N colors each comprise M sub-colors.

In other words, the number of sub-colors forming a color is identical for all the colors. This gives, firstly, a system architecture balanced between the different ground stations and, secondly, a throughput rate (quantity of information transmitted) that is balanced between the different spots.

In one variant, the number of sub-colors forming a color is different from one color to another. This variant is adapted to the case where the quantity of information transmitted by the (satellite or aircraft type) relay device is variable from one color to another (a color with a higher throughput rate being then divided into a greater number of sub-colors).

In one variant, at least one color is not divided (one of the ground stations possesses the capacity to convey all the information of this color) and at least one color is divided into sub-colors.

In a third particular implementation, for at least two sub-colors each resulting from a division of a distinct color among the N colors, one of the ground stations transmits, to the relay device, all the information intended for transmission by the relay device with said at least two sub-colors.

While enabling the implementation of the intra-system interference cancellation algorithms, this third implementation offers a same service on the spots covered with said at least two sub-colors.

According to one particular aspect of this third implementation, the N colors each comprises M′ sub-colors and each of the M′ ground stations is dedicated to an j^{th} specific sub-color of each of the N colors, j∈{1 . . . M′}, and transmits, to the relay device, all the information intended for transmission by the relay device with the N j^{th} specific sub-colors of the N colors.

In this particular case of the third implementation, a same service is offered on the totality of the terrestrial geographical coverage zone (i.e. all the spots). Thus, a total loss of coverage is prevented in all the spots. Indeed, in the event of unavailability of one of the ground stations, the proposed solutions enables a partial coverage of all the spots since they receive each of the pieces of information transmitted by the ground stations other than the one that is unavailable. Furthermore, the capacity of this service can gradually expand through the increase, as and when needed, of the number of ground stations in operation.

Another embodiment of the invention proposes a ground station of a telecommunications system with multi-spot geographical coverage and comprising an outbound path to transmit information, via a satellite or aircraft type relay device, from a plurality of ground stations to a plurality of terminals located in spots distributed in a terrestrial geographical coverage zone, the outbound path comprising a plurality of a uplinks, each from one of the ground stations to the relay device, and a plurality of downlinks, each from the relay device to one of the spots, each of downlinks being associated with a color in an N-color re-use scheme, with N≥2, each color corresponding a distinct frequency band or to a distinct pair associating a frequency and a polarization. Said ground station comprises means of transmission, to the relay device, of all the information intended for transmission by the relay device with at least one given color among the N colors or with at least one given sub-color of at least one given color, said at least one given sub-color being one of the M sub-colors resulting from a division of the given color and being each associated with a sub-band of the frequency band associated with the given color or with a distinct pair associating a sub-band of the frequency band associated with the given color and the polarization associated with the given color, each downlink associated with said at least one given color using the M sub-colors with M M≥2.

Another embodiment of the invention proposes a satellite or aircraft type relay device for a telecommunication system with multi-spot geographical coverage and comprising an outbound path to transmit information via said relay device, from a plurality of ground stations towards the plurality of terminals located in spots distributed in a terrestrial geographical coverage zone, the outbound path comprising a plurality of uplinks, each from one of the ground stations to said relay device and a plurality of downlinks, each from said relay station to one of the spots, each of the downlinks being associated with a color in an N-color re-use scheme, with N≥2, each color corresponding to a distinct frequency band or to a distinct pair associating a frequency band and a polarization. Said relay device comprises means of reception, on one of the uplinks, of all the information intended for transmission on certain of the downlinks with at least one given color among the N colors or with at least one given sub-color of at least one given color, said at least one given sub-color being one of the M sub-colors resulting from a division of the given color and being each associated with a sub-band of the frequency band associated with the given color or with a distinct pair associating a sub-band of the frequency band associated with the given color and the polarization associated with the given color, each downlink associated with said at least one given color using the M sub-colors, with M≥2.

Advantageously, the ground station and the relay device comprise means of implementing the steps that they perform in the method as described here above, in any one of its different implementations.

### 5. LIST OF FIGURES

Other features and advantages of the invention shall appear from the following description, given by way of an indicative and non-exhaustive example and from the appended drawings, of which:

FIG. 1, already described with reference to the prior art, illustrates an example of a satellite telecommunications system with multi-spot geographical coverage;

FIG. 2A, already described with reference to the prior art, illustrates the deployment of the multi-spot system of FIG. 1 in the Europe zone;

FIG. 2B, described with reference to the prior art, illustrates an example of a meshing between 11 ground stations;

FIG. 3, already described with reference to the prior art, illustrates an example of transmission of information from a plurality of ground stations to a plurality of spots, via a satellite, according to a first known solution;

FIG. 4 illustrates an example of transmission of information from a plurality of ground stations to a plurality of spots, via a satellite, according to a first embodiment of the invention (to be compared with the first known solution of FIG. 3);

FIG. 5A illustrates an example of transmission of information from a plurality of ground stations to a plurality of spots, via a satellite, according to a second embodiment of the invention (to be compared with the second known solution of FIG. 6);

FIG. 5B presents an example of an architecture of the payload of the satellite of FIG. 5A;

FIG. 6 illustrates an example of transmission of information from a plurality of ground stations to a plurality of spots via a satellite according to a second known solution;

FIG. 7A illustrates an example of transmission of information from a plurality of ground stations to a plurality of spots via a satellite according to a third embodiment of the invention; and

FIG. 7B presents an example of architecture of the payload of the satellite of FIG. 7A.

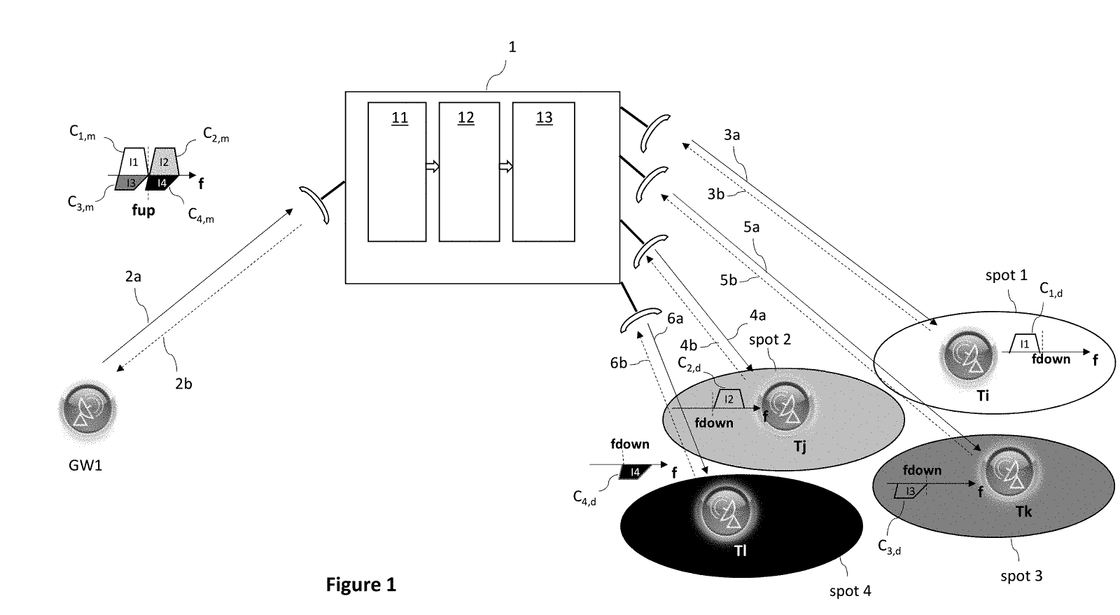

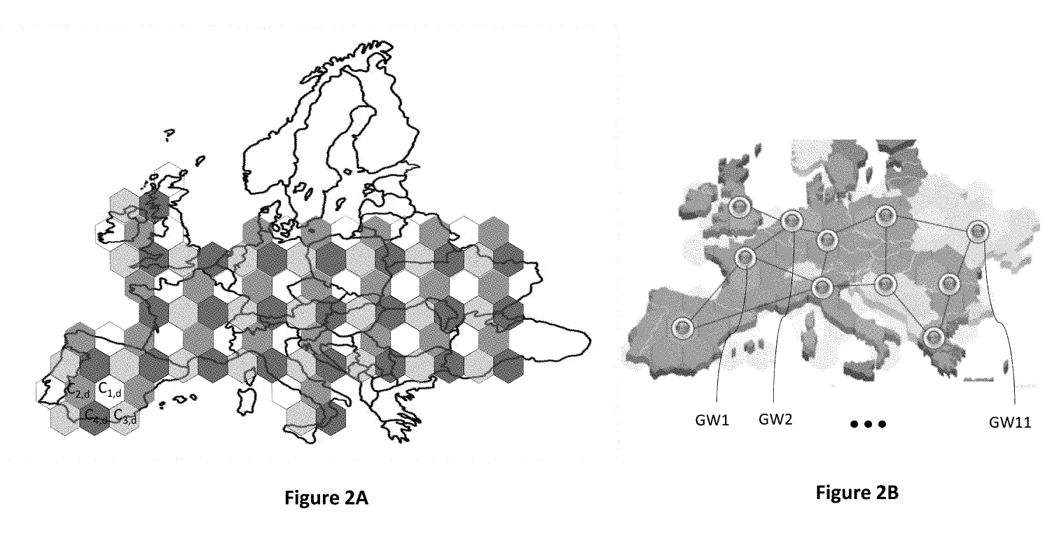

### 6. DETAILED DESCRIPTION

In all the figures of the present document, the identical elements are designated by a same numerical reference.

Here below in the description, several embodiments of the invention are presented by way of a non-exhaustive illustration in the case where the relay device is a satellite. It is clear that the present invention is not limited to this type of relay device and can equally well be applied when the relay device is an airborne vehicle (aircraft, drone, dirigible, balloon, etc.), for example a high altitude platform (HAPS).

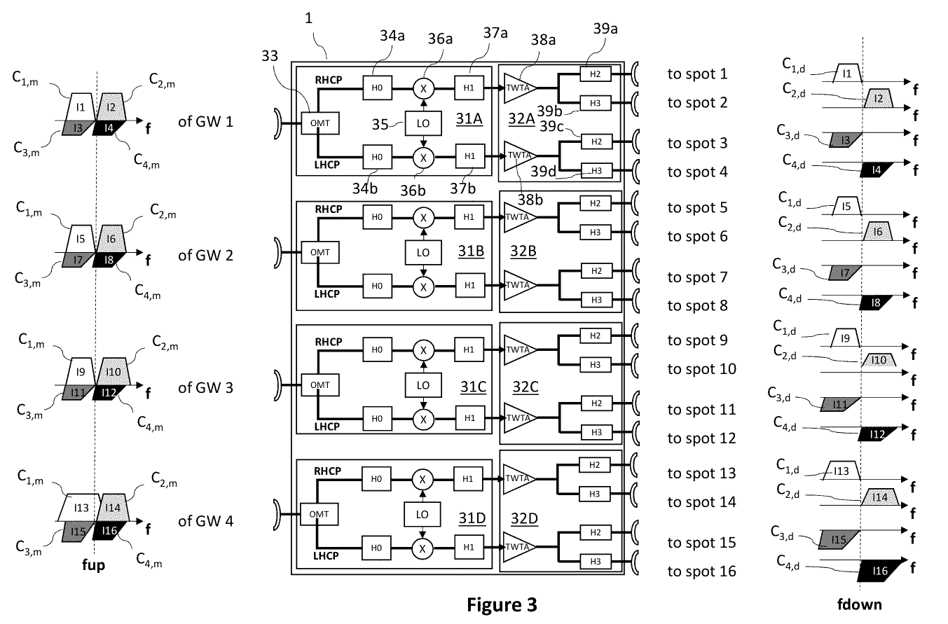

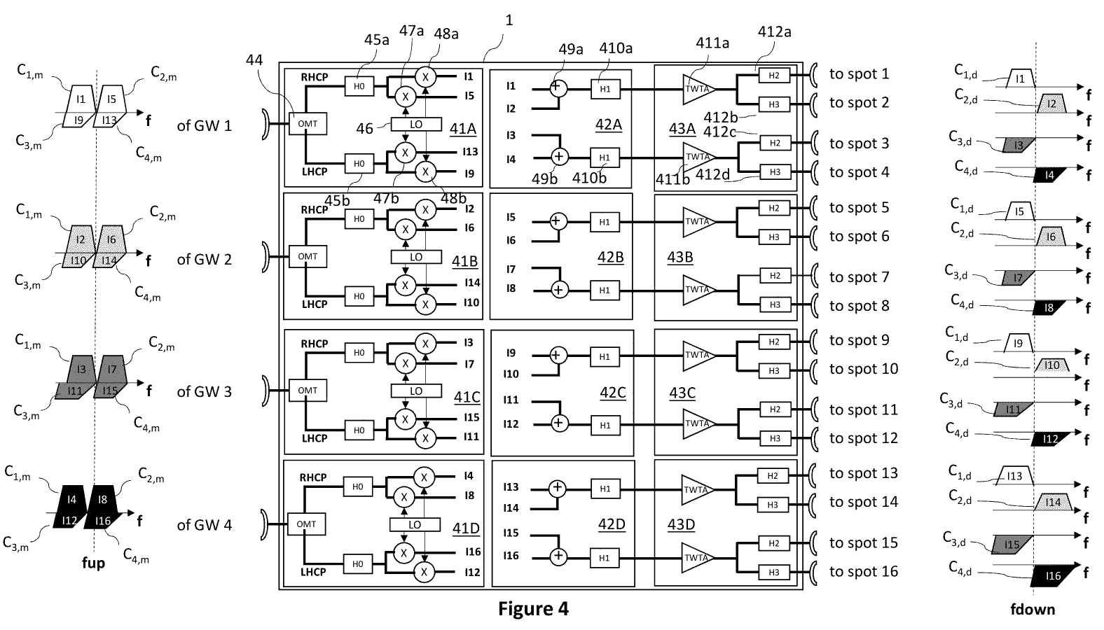

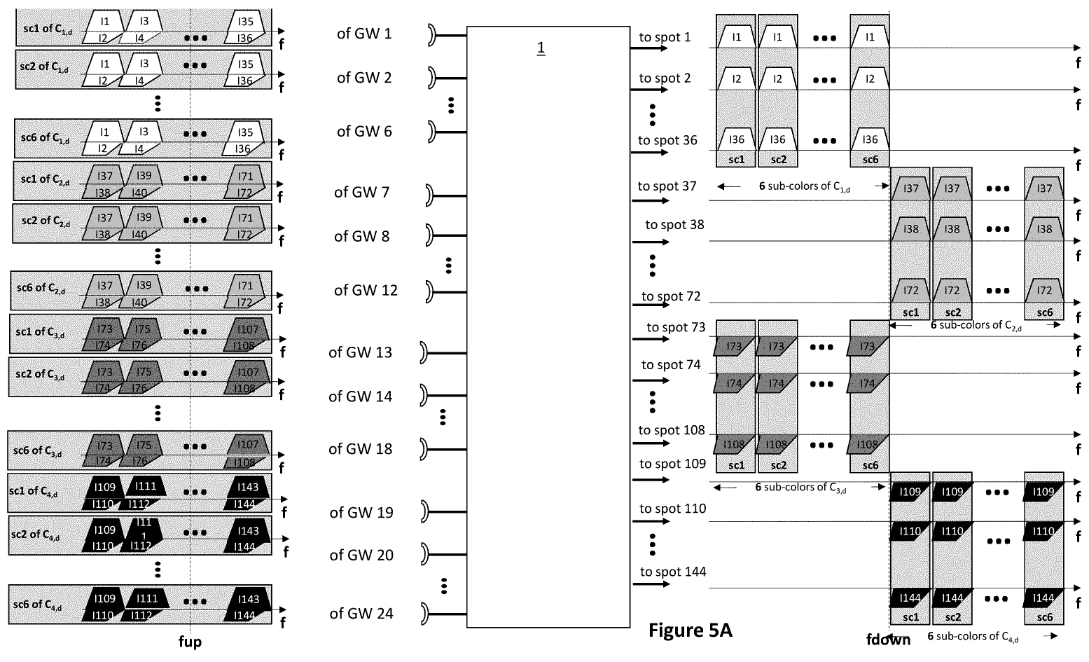

Referring now to FIG. 4, we present an example of a transmission of information from four ground stations GW1 to GW4 towards 16 spots (spot 1 to spot 16) via a satellite 1 in a first embodiment of the invention (to be compared with the first solution like that of FIG. 3).

The ground station GW1 transmits information I1, I5, I9 and I13 to the satellite. This is information on the first colors C_{1,m}, C_{2,m}, C_{3,m} and C_{4,m} respectively (see definitions further above). The ground station GW2 transmits, to the satellite, the pieces of information I2, I6, I10 and I14 on the same first colors C_{1,m}, C_{2,m}, C_{3,m} and C_{4,m} respectively. The ground station GW3 transmits, to the satellite, the pieces of information I3, I7, I11 and I15 on the same first colors C_{1,m}, C_{2,m}, C_{3,m} and C_{4,m} respectively. The ground station GW4 transmits, to the satellite, the pieces of information I4, I8, I12 and I16 on the same first colors C_{1,m}, C_{2,m}, C_{3,m} and C_{4,m} respectively.

The satellite retransmits the pieces of information I1, I5, I9 and I13 on the color C_{1,d} (see definition further above) to the spots 1, 5, 9 and 13 respectively. It retransmits the pieces of information I2, I6, I10 and I14 on the color C_{2,d} (see definitions further above) towards the spots 2, 6, 10 and 14 respectively. It retransmits the pieces of information I3, I7, I11 and I15 on the color C_{3,d} (see definitions further above) towards the spots 3, 7, 11 and 15 respectively. It retransmits the pieces of information I4, I8, I12 and I16 on the color C_{4,d} (see definitions further above) to the spots 4, 8, 12 and 16 respectively.

Each of the four ground stations GW1 to GW4 is therefore dedicated to a specific color among the four colors C_{1,d}, C_{2,d}, C_{3,d} and C_{4,d} and transmits, to the satellite 1, all the information that has to be transmitted by the satellite with this specific color. The use of interference cancelling algorithms therefore does not call for any ground infrastructure (communications network between the ground stations) to convey information on the interfering ground stations as well as the correction parameters to be applied to the interferences.

FIG. 4 presents an (illustratory and non-exhaustive) example of architecture of the payload of the satellite 1 comprising four input blocks 41A to 41D followed by four intermediate blocks 42A to 42D and then four output blocks 43A to 43D.

The blocks mentioned here above and described in detail here below in the description are functional blocks, the functions of which can be carried out equally well in hardware form and/or in software form, for example by the processing of a signal or of the software in a digital transparent digital signal processor (DTP).

In practice and conventionally, these blocks cooperate with a block for setting the relative level of the power spectral densities of the various ground stations. This setting block (not shown in FIG. 4) is either on board (i.e. in the payload of the satellite) or on the ground (i.e. in a land equipment).

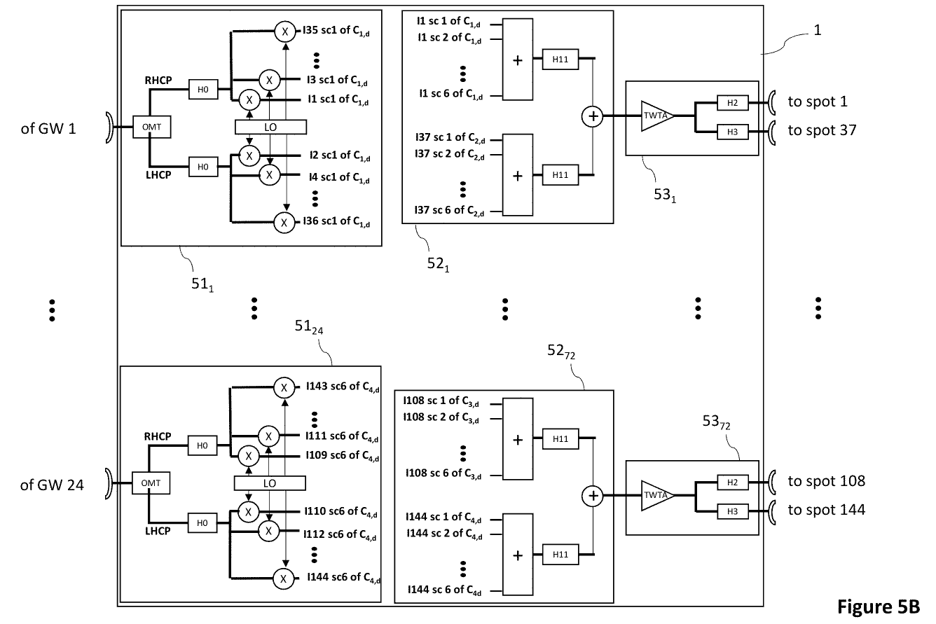

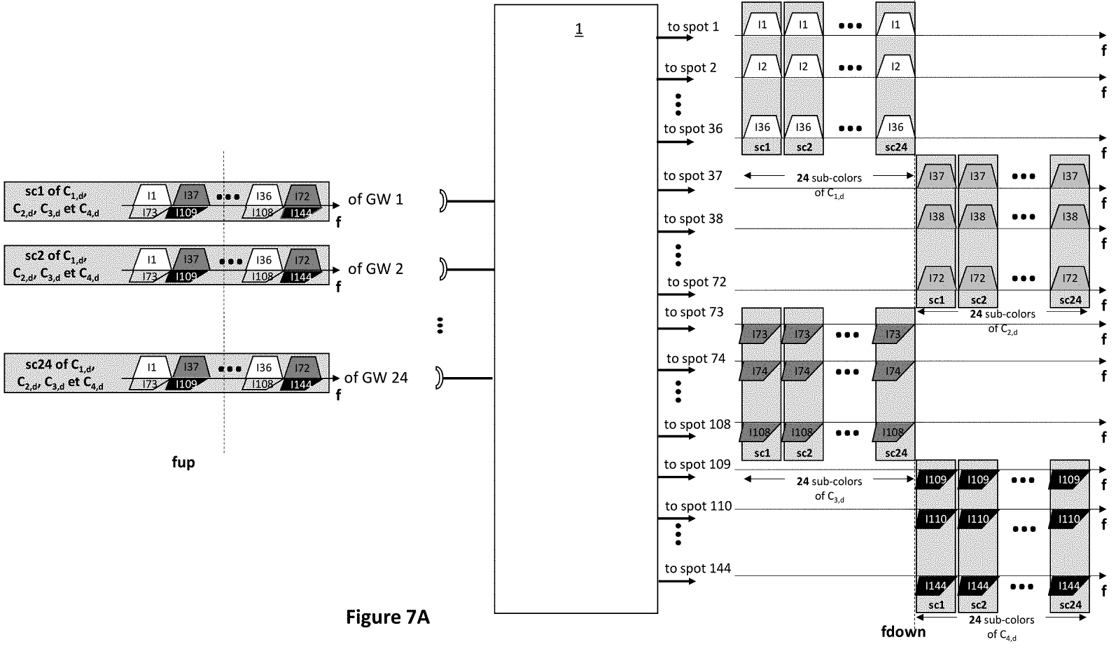

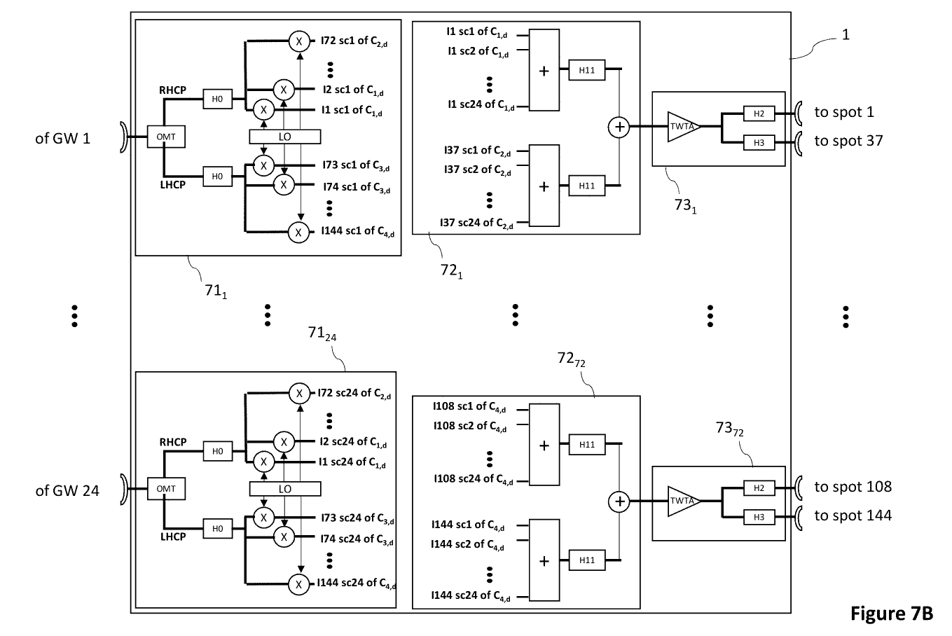

These observations (on the functional blocks co-operating with a setting block) can equally well be applied to the blocks of FIGS. 5B and 7B described here below.

Each of the input blocks 41A to 41D receives signals coming from one of the ground stations. We shall now give a detailed description of the input block 41A which receives the pieces of information I1, I5, I9 and I13 transmitted by the ground station GW1.

It comprises a polarizing duplexer or orthomode transducer (OMT) 44 enabling the separation of the signals according to their polarization (right-hand circular polarization (RHCP) or left-hand circular polarization (LHCP)), and two arms each dedicated to a distinct polarization. Each arm of the block 41A comprises a first filter (H0) 45a, 45b followed by two frequency transposers 47a, 48a and 47b, 48b in parallel:
one transposer (48a, 48b) carries out a first transposition of the received frequencies, from the frequency fᵤₚ to the frequency f_{down} (by multiplication by a first frequency given by an local oscillator (LO) 35). With this first transposition, the frequency band of the color C_{1,m} (carrying the piece of information I1) is transposed into a frequency band of the color C_{1,d} (transporting the same piece of information I1). In the same way, the frequency band of the color C_{3,m} (transporting the piece of information I9) is transposed into a frequency band of the color C_{1,d} (transporting the same piece of information I9);
the other frequency transposer (47a, 47b) carries out a second transposition of the received spectrum, slightly offset relative to the first transposition (by multiplication by a second frequency given by the local oscillator (LO) 35). With this second transposition, the frequency band of the color C_{2,m} (transporting the piece of information I5) is transposed into a frequency band of the color C_{1,d} (transporting the same information I5). Similarly, the frequency band of the color C_{4,m} (transporting the piece of information I13) is transposed into a frequency band of the color C_{1,d} (transporting the same piece of information I13).

Each of the intermediate blocks 42A to 42D receives information signals coming from the four input blocks 41A to 41D. We shall now give a detailed description of the intermediate block 42A which receives information signals I1, I2, I3 and I4. It comprises two arms each comprising an adder 49a, 49b (combining two of the four information signals received) followed by a second filter (H1) 410a, 410b. Thus, the signals corresponding to the pieces of information I1 and I2 are combined and, in parallel, the signals corresponding to the pieces of information I3 and I4 are combined.

Each of the output blocks 43A to 43D is identical to one of the blocks 32A to 32D of FIG. 3 and receives the two signals output from one of the four intermediate blocks 42A to 42D. We shall now provide a detailed description of the output block 43A that receives the signals output from the intermediate block 42A. It comprises two arms each comprising an amplifier (TWTA) 411a, 411b (receiving the output signal from the second filter of one of the two arms of the block 42A), the output of which feeds two filters (H2) 412a, 412c and (H3) 412b, 412d disposed in parallel and enabling the signal to be sub-divided into two sub-bands corresponding to the colors C_{1,d} and C_{2,d} for the right-hand circular polarization (colors used for sending to the spots 1 and 2) and to the colors C_{3,d} and C_{4,d} for the left-hand circular polarization (colors used for sending to the spots 3 and 4).

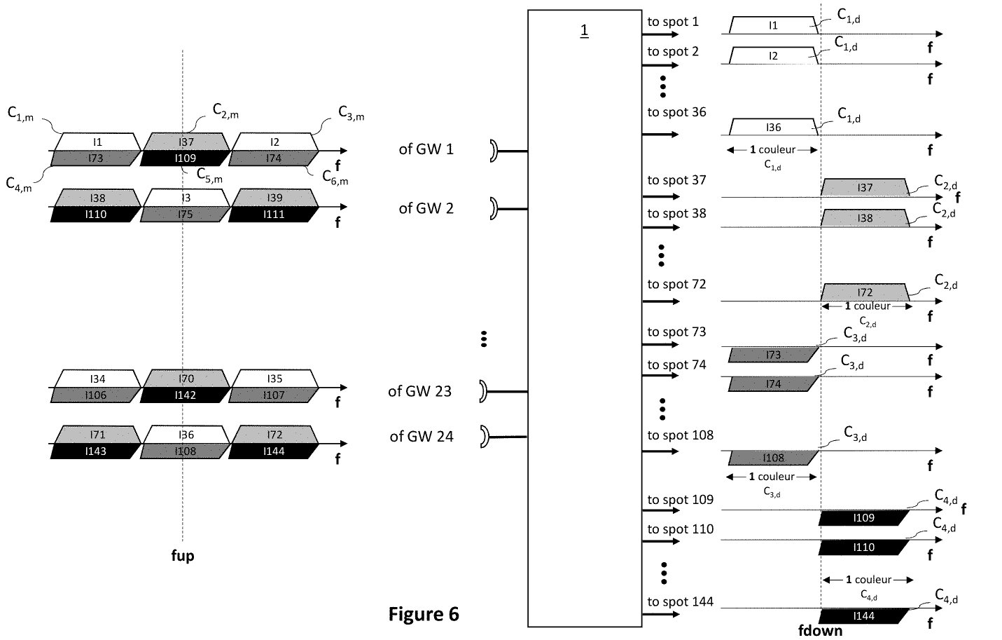

Referring now to FIG. 5A, we present an example of transmission of information from 24 ground stations GW1 to GW24 to 144 spots (spot 1 to spot 144) via a satellite 1 according to a second embodiment of the invention (to be compared with the second known solution of FIG. 6 discussed here below).

In this second embodiment, each of the four colors C_{1,d} to C_{4,d} is divided into six sub-colors (denoted sc1 to sc6). There are therefore 24 sub-colors in all. Each of the 24 ground stations is dedicated to a specific sub-color among these 24 sub-colors and transmits, to the satellite, all the information intended for transmission by the satellite with this specific sub-color. Thus, the interference cancelling algorithms (by subtraction at source) can be applied without any need for a network link between the ground stations.

For example, for the six colors sc1 to sc6 of the color C_{1,d}:
the ground station GW1 transmits, to the satellite, a first part of the pieces of information I1 to I36 intended for retransmission by the satellite to the spot 1 to 36 respectively with the sub-color sc1 of C_{1,d};
the ground station GW2 transmits, to the satellite, a second part of the pieces of information I1 to I36 intended for retransmission by the satellite to the spots 1 to 36 respectively, with this sub-color sc2 of C_{1,d};
. . . ;
the ground station GW6 transmits, to the satellite, a second part of the pieces of information I1 to I36 that are to be retransmitted by the satellite to the spots 1 to 36 respectively, with the sub-color sc6 of C_{1,d}.

In the same way, each of the six ground stations GW7 to GW12 transmits, to the satellite, a distinct part of the pieces of information I37 to I72 intended for retransmission by the satellite to the spots 37 to 72 respectively, with one of the sub-colors sc1 to sc6 of C_{2,d}. Each of the six ground stations GW13 to GW18 transmits, to the satellite, a distinct parts of the pieces of information I73 to I108 intended for retransmission by the satellite to the spots 73 to 108 respectively with one of the sub-colors sc1 to sc6 of C_{3,d}. Each of the six ground stations GW19 to GW24 transmits, to the satellite, a distinct part of the pieces of information I109 to I144 intended for retransmission by the satellite to the spots 109 to 144 respectively, with one of the sub-colors sc1 to sc6 of C_{4,d}.

Another worthwhile feature of the solution of FIG. 5A is the partial coverage of all the spots of a same color in the event of unavailability of one of the ground stations feeding these spots with information. For example, in the event of unavailability of the ground station GW1, the spots 1 to 36 are partially covered with the parts of information transmitted on the sub-colors sc2 to sc6 of C_{1,d} (all that is missing therefore is the parts of information transmitted on the sub-color sc1 of C_{1,d}). Hence, only one-sixth of the capacity of the spots 1 to 36 is lost (there is no total loss of these spots).

FIG. 5B presents an example of an architecture of the payload of the satellite 1 of FIG. 5A comprising 24 input blocks 51₁ to 51₂₄ followed by 72 intermediate blocks 52₁ to 52₇₂ and then 72 output blocks 53₁ to 53₇₂.

Each of the 24 input blocks 51₁ to 51₂₄ receives signals coming from one of the ground stations. We shall now provide a detailed description of the input block 51₁ which receives (from the ground station GW1) of first part of the pieces of information I1 to I36, intended for retransmission by the satellite to the spots 1 to 36 respectively, with the sub-color sc1 of C_{1,d}. The input block 51₁ comprises a polarization duplexer or orthomode transducer (OMT), used to separate the signals according to their polarization (right-hand circular polarization (RHCP) or left-hand circular polarization (LHCP)), and two arms each dedicated to a distinct polarization. Each arm of the input block 51₁ comprises a first filter (H0) followed by 18 parallel frequency transposers. Each of the 36 transposers (18 per arm) carries out a frequency transposition fᵤₚ towards a particular frequency so that a part of each of the pieces of information I1 to I36 (the part coming from the ground station GW1) is transposed into the frequency band of the sub-color sc1 of the color C_{1,d}. The working of the other input blocks 51₂ to 51₂₄ can easily be deduced from that of the input block 51₁.

Each of the 72 intermediate blocks 52₁ to 52₇₂ receives information signals coming from certain of the input blocks. We shall now describe in detail the intermediate block 52₁ that receives, on a first arm, the six parts of the pieces of information I1 that have preliminarily been transposed to the frequency bands of six sub-colors sc1 to sc6 of the color C_{1,d} and on the second arm, the six parts of the pieces of information I37 that have preliminarily been transposed into the frequency bands of the six sub-colors sc1 to sc6 of the color C_{2,d}. The intermediate block 52₁ comprises, in each of its arms, an adder (combining the six information signals received) followed by a second filter (H11). Thus, the signals corresponding to the six parts of the information I1 are combined and in parallel the six signals corresponding to the six parts of the information I37 are combined. The intermediate block 52₁ also comprises another adder enabling the adding together of the signals coming from the two arms to form the output signal of the intermediate block 52₁.

Each of the 72 output blocks 53₁ to 53₇₂ is identical to one of the two arms of the blocks 32A to 32D of FIG. 3 and receives the signal output from one of the 72 intermediate blocks 52₁ to 52₇₂. We shall now describe in detail the output block 53₁ which receives the signal output from the intermediate block 52₁. It comprises two arms each comprising an amplifier (TWTA), the output of which feeds two filters (H2, H3) disposed in parallel, each filter enabling the preservation of the band corresponding to the colors C_{1,d} and C_{2,d} respectively (colors used for sending to the spots 1 and 37).

FIG. 6 illustrates an example of transmission of information from a plurality of ground stations to a plurality of spots via satellite according to a second known solution (to be compared with the novel solution of FIG. 5A, the two solutions corresponding to a same number of ground stations, a same number of spots and to a same frequency domain to transmit a same information throughput rate).

In the example of FIG. 6, it is assumed that the architecture of the payload of the satellite 1 is equivalent to that of the example of FIG. 3 (first known solution). The difference is that the payload of the satellite receives six information elements from a same ground station (instead of four) and retransmits them to the six spots (instead of four).

The transmission of information from 24 ground stations GW1 to GW24 to 144 spots (spot 1 to spot 144) via a satellite 1 is done as follows:
the ground station GW1 transmits, to the satellite, six pieces of information I1, I37, I2, I73, I109 and I74 intended for retransmission by the satellite to the spots 1, 37, 2, 73, 109 and 74 respectively with the colors C_{1,d}, C_{2,d}, C_{1,d}, C_{3,d}, C_{4,d} and C_{3,d};
the ground station GW2 transmits, to the satellite, six pieces of information I38, I3, I39, I110, I75 and I111 intended for retransmission by the satellite to the spots 38, 3, 39, 110, 75 and 111 respectively with the colors C_{2,d}, C_{1,d}, C_{2,d}, C_{4,d}, C_{3,d} and C_{4,d};
. . . ;
the ground station GW24 transmits, to the satellite, six pieces of information, intended for retransmission by the satellite to the spots 71, 36, 72, 143, 108 and 144 respectively with the colors C_{2,d}, C_{1,d}, C_{2,d}, C_{4,d}, C_{3,d} et C_{4,d}.

It is seen that the pieces of information I1, I3, I34 and I36 for example, retransmitted by the satellite with the color C_{1,d} to the spots 1, 3, 34, 36 are sent out by different ground stations (GW1, GW2, GW23 and GW24 respectively). The implementation of the interference cancellation algorithms therefore requires, in this case, a dedicated communications network between the ground stations.

Referring now to FIG. 7A, we present an example of transmission of information from 24 ground stations GW1 to GW24 towards 144 spots (spot 1 to spot 144) via a satellite 1 in a third embodiment of the invention.

In this third embodiment, each of the four colors C_{1,d} to C_{4,d} is divided into 24 sub-colors (denoted sc1 to sc24). There are therefore 96 sub-colors in all. Each of the 24 ground stations is dedicated to an j^{th} specific sub-color of each of the four colors, j∈{1 . . . 24}, and transmits, to the satellite, all the information to be transmitted by the satellite with the four j^{th} specific sub-colors of the four colors.

For example, the ground station GW1 transmits the following to the satellite:
a first part of the pieces of information I1 to I36 intended for retransmission by the satellite to the spots 1 to 36 respectively, with the sub-color sc1 of C_{1,d};
a first part of the pieces of information I37 to I72, intended for retransmission by the satellite, to the spots 37 to 72 respectively, with the sub-color sc1 of C_{2,d};
a first part of the pieces of information I73 to I108, intended for retransmission by the satellite, to the spots 73 to 108 respectively with the sub-color sc1 or C_{3,d}; and
a first part of the pieces of information I109 to I144 intended for retransmission by the satellite, to the spots 109 a 144 respectively, with the sub-color sc1 of C_{4,d}.*

Thus, the interference cancellation algorithms (by subtraction at source) can be applied without any need for a network link between the ground stations.

Another value of this third embodiment is that a same service is offered on the totality of the terrestrial geographic coverage zone (i.e. all the spots). Thus, a total loss of coverage in all the spots is prevented. Indeed, in the event of unavailability of one of the ground stations, the proposed solution enables a partial coverage of all the spots since they each receive information transmitted by the ground stations other than the station that is unavailable. For example, in the event of unavailability of the ground station GW1, all the spots 1 to 144 are partially covered with:
the parts of information transmitted on the sub-colors sc2 to sc24 of C_{1,d} (the only parts of information missing, therefore, are those transmitted on the sub-color sc1 of C_{1,d}) for the spots 1 to 36;
the parts of information transmitted on the sub-colors sc2 to sc24 of C_{2,d} (the only parts of information missing, therefore, are those transmitted on the sub-color sc1 of C_{2,d}) for the spots 37 to 72;
the parts of information transmitted on the sub-colors sc2 to sc24 of C_{3,d} (the only parts of information missing, therefore, are those transmitted on the sub-color sc1 of C_{3,d}) for the spots 73 to 108;
the parts of information transmitted on the sub-colors sc2 to sc24 of C_{4,d} (the only parts of information missing, therefore, are those transmitted on the sub-color sc1 of C_{4,d}) for the spots 109 to 44.

In addition, the capacity of the service can gradually expand, in increasing the number of ground stations in operation as and when needed (for example, in adding a twentieth ground station if necessary).

FIG. 7B presents an example of architecture of the payload of the satellite 1 of FIG. 7A comprising 24 input blocks 71₁ to 71₂₄ followed by 72 intermediate blocks 72₁ to 72₇₂, and then 72 output blocks 73₁ to 73₇₂.

Each of the 24 input blocks 71₁ to 71₂₄ receives signals coming from one of the ground stations. We shall now provide a detailed description of the input block 71₁ which receives signals coming from the ground station GW1 (see details further above).

The input block 71₁ comprises a polarization duplexer or orthomode transducer (OMT) enabling the separation of the signals according to their polarization (right-hand circular polarization (RHCP) or left-hand circular polarization (LHCP)) and two arms each dedicated to a distinct polarization. Each arm of the input block 71₁ comprises a first filter (H0) followed by 72 parallel frequency transposers. Each of the 144 transposers (72 per arm) carries out a transposition from the frequency fᵤₚ to a particular frequency so that:
for each of the pieces of information I1 to I36, the part coming from the ground station GW1 is transposed into the frequency band of the sub-color sc1 of the color C_{1,d};
for each of the pieces of information I37 to I72, the part coming from the ground station GW1 is transposed to the frequency band of the sub-color sc1 of the color C_{2,d};
for each of the pieces of information I73 to I108, the part coming from the ground station GW1 is transposed to the frequency band of the sub-color sc1 of the color C_{3,d};
for each of the pieces of information I109 a I144, the part coming from the ground station GW1 is transposed to the frequency band of the sub-color sc1 of the color C_{4,d}.

The operation of the other input blocks 71₂ to 71₂₄ can easily be deduced from that of the input block 71₁.

Each of the 72 intermediate blocks 72₁ to 72₇₂ receives information signals coming from certain of the input blocks. We shall now provide a detailed description of the intermediate block 72₁ that receives the following: on a first arm, the 24 parts of the piece of information I1 that have preliminarily been transposed into the frequency band of the 24 sub-colors sc1 to sc24 of the color C_{1,d}, and on a second arm, the 24 parts of the piece of information I37 which have preliminarily been transposed into the frequency bands of the 24 sub-colors sc1 to sc24 of the color C_{2,d}. The intermediate block 72₁ comprises, in each of its arms, an adder (combining the 24 information signals received) followed by a second filter (H11). Thus, the signals corresponding to the 24 parts of the information I1 are combined and, in parallel, the signals corresponding to the 24 parts of the information I37 are combined. The intermediate block 72₁ also comprises another adder enabling the adding up of the signals coming from the two arms to form the output signal of the intermediate block 72₁.

The 72 output blocks 73₁ to 73₇₂ are identical to the 72 output blocks 53₁ to 53₇₂ of FIG. 5. Each receives the signal output from one of the 72 intermediate blocks 72₁ to 72₇₂.

In an exemplary embodiment, the functions of the satellite can be carried out by hardware or software, such as a processor executing software instructions stored in a non-transitory computer-readable medium. Similarly, the functions of the ground station can be carried out by hardware or software, such as a processor executing software instructions stored in a non-transitory computer-readable medium.

An exemplary embodiment of the present invention overcomes the different drawbacks of the prior art.

More specifically, an exemplary embodiment of the invention provides a solution to implement intra-system interference cancellation algorithms in a telecommunications system via a satellite or aircraft type relay device with multi-spot geographical coverage with an N-color re-use scheme.

An exemplary embodiment of the invention provides a solution enabling the implementing of intra-system interference cancellation algorithms while at the same time preventing total loss of a spot even in the event of unavailability of a ground station.

An exemplary embodiment of the invention provides such a solution enabling the implementing of intra-system interference cancellation algorithms while offering a same level service on the totality of the terrestrial geographic coverage zone (i.e. all the spots), the capacity of this service being able, if necessary, of gradually expanding.

An exemplary embodiment of the invention provides such a solution that is easy to implement and costs little in terms of both ground stations and relay devices (of the satellite or aircraft type).

1. A method telecommunications in a multi-spot geographical coverage system comprising an outbound path to transmit information, via a satellite or aircraft type relay device, from a plurality of ground stations to a plurality of terminals located in spots distributed in a terrestrial geographical coverage zone, the outbound path comprising a plurality of uplinks, each from one of the ground stations to the relay device, and a plurality of downlinks each from the relay device to one of the spots, each of the downlinks being associated with a color in an N-color re-use scheme, with N≥2, each color corresponding to a distinct frequency band or to a distinct pair associating a frequency band and a polarization, wherein the method comprises:
for at least one given color among the N colors or for at least one given sub-color of at least one given color, one of the ground stations transmitting to the relay device all the information intended for transmission by the relay device with said at least one given color or with said at least one given sub-color, said at least one given sub-color being one of M sub-colors resulting from a division of the given color and being each associated with a sub-band of the frequency band associated with the given color or with a distinct pair associating a sub-band of the frequency band associated with the given color and the polarization associated with the given color, each downlink associated with said at least one given color using the M sub-colors, with M≥2.

2. The method according to claim 1, wherein each of N ground stations is dedicated to a specific color among the N colors and transmits, to the relay device, all the information intended for retransmission by the relay device with said specific color.

3. The method according to claim 1, wherein each of M ground stations is dedicated to a specific sub-color among the M sub-colors resulting from the division of said at least one given color and transmits, to the relay device, all the information intended for transmission by the relay device with said specific sub-color.

4. The method according to claim 3, each of S ground stations is dedicated to a specific sub-color among S sub-colors and transmits, to the relay device, all the information intended for transmission by the relay device with said specific sub-color, where S=M₁+M₂+ . . . +M_{N}, with Mᵢ being the number of sub-colors of the i^{th} of the N colors, i∈{1 . . . N}

5. The method according to claim 4, wherein the N colors each comprise M sub-colors.

6. The method according to claim 1, wherein, for at least two sub-colors each resulting from a division of a distinct color among the N colors, one of the ground stations transmits, to the relay device, all the information intended for transmission by the relay device with said at least two sub-colors.

7. The method according to claim 6, wherein the N colors each comprise M′ sub-colors, and each of the M′ ground stations is dedicated to an j^{th} specific sub-color of each of the N colors, j∈{1 . . . M′}, and transmits, to the relay device, all the information intended for transmission by the relay device with the N j^{th} specific sub-colors of the N colors.

8. A ground station of a telecommunications system with multi-spot geographical coverage and comprising an outbound path to transmit information, via a satellite or aircraft type relay device, from a plurality of ground stations to a plurality of terminals located in spots distributed in a terrestrial geographical coverage zone, the outbound path comprising a plurality of a uplinks, each from one of the ground stations to the relay device, and a plurality of downlinks, each from the relay device to one of the spots, each of the downlinks being associated with a color in an N-color re-use scheme, with N≥2, each color corresponding to a distinct frequency band or to a distinct pair associating a frequency band and a polarization, said ground station comprising:
a processor configured to perform acts comprising:
transmitting, to the relay device, all the information intended for transmission by the relay device with at least one given color among the N colors or with at least one given sub-color of at least one given color, said at least one given sub-color being one of the M sub-colors resulting from a division of the given color and being each associated with a sub-band of the frequency band associated with the given color or with a distinct pair associating a sub-band of the frequency band associated with the given color and the polarization associated with the given color, each downlink associated with said at least one given color using the M sub-colors with M≥2.

9. A satellite or aircraft type relay device for a telecommunication system with multi-spot geographical coverage and comprising an outbound path to transmit information via said relay device, from a plurality of ground stations towards the plurality of terminals located in spots distributed in a terrestrial geographical coverage zone, the outbound path comprising a plurality of uplinks, each from one of the ground stations to said relay device and a plurality of downlinks, each from said relay station to one of the spots, each of the downlinks being associated with a color in an N-color re-use scheme, with N≥2, each color corresponding to a distinct frequency band or to a distinct pair associating a frequency band and a polarization, said relay device comprising:
a processor configured to perform acts comprising:
receiving, on one of the uplinks, of all the information intended for transmission on certain of the downlinks with at least one given color among the N colors or with at least one given sub-color of at least one given color, said at least one given sub-color being one of the M sub-colors resulting from a division of the given color and being each associated with a sub-band of the frequency band associated with the given color or with a distinct pair associating a sub-band of the frequency band associated with the given color and the polarization associated with the given color, each downlink associated with said at least one given color using the M sub-colors, with M≥2.
